(19) United States
(12) Patent Application Publication
(10) Pub. No.: US 2010/0288455 A1
(43) Pub. Date: Nov. 18, 2010

(54) Window screen

(76) Inventor: Tanya Liscano, Clovis, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/454,313

(22) Filed: May 15, 2009

(51) Int. Cl. E06B 9/24

(52) U.S. Cl. 160/372

(57) ABSTRACT

An improved window screen configured to allow a person to easily and quickly remove the window screen from a window frame without damaging the window screen, window frame or window. The improved window screen has a screen frame comprising a first C-shaped section and a second C-shaped section that are configured to slidably engage each other to move the screen frame between an extended position in the window frame and a retracted position for removing or installing the window screen in the window frame. The screen frame also comprises a securing mechanism, which in the preferred embodiment is a ball detent device, that secures the screen frame in its extended position and which is disengaged to move the screen frame to its retracted position. The window screen of the present invention eliminates the need to bend, flex or twist the window screen to remove it from the window frame.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

A. Field of the Invention

The field of the present invention relates generally to window screens and, more particularly, to removable window screens having a fiber mesh panel that is supported on its outer perimeter by a frame. Even more particularly, the present invention relates to such window screens that are configured to allow the user to easily remove and install the window screen in a window frame.

B. Background

Most American homes utilize window screens to partially close an opening in a window that would otherwise be completely open to the outside. As is well known, an open window allows the resident of a home to take advantage of cooler outside temperatures and breezes to cool and freshen the interior of the home. An open window, however, is likely to result in a virtual invasion of insects, particularly flying insects, that will enter the home through the open window. This is a particular concern in areas of the country where mosquitos are a problem. In addition to insects entering a home, leaves, debris, birds, bats and other animals can enter the home through an open window. In contrast, a window which has a window screen positioned in the window opening allows a person in the home to open the window to take advantage of the cooler outside air temperature and/or breezes to cool and circulate air through the interior of the house, which would otherwise be stuffy or require the operation of an air conditioner or evaporative cooler, without allowing insects or other items in the home. As a result, window screens allow residents to lower their electrical utility costs by reducing reliance on high electrical use air conditioners and coolers.

The typical window screen comprises a semi-rigid screen frame with a mesh panel which is stretched between and attached to the frame members of the screen frame. Screen frames are made out of a variety of materials, with aluminum, wood or fiberglass likely being the most common. The mesh panels are made out of metal wire, most commonly aluminum, fiberglass, or synthetic fiber mesh. Other metals, including bronze, copper, brass, stainless steel and galvanized steel are also utilized for the mesh panel. Although less common, screen frames and their mesh panels are also made out plastics and other materials.

Most window screens are received in a window opening in a manner that allows the screen to be removed from the window for cleaning, replacement in case of damage or to allow access into the home through the window. Some windows utilize an external clip or other locking mechanism to secure the window screen to the window. More commonly, however, the frame of the window screen is received inside a slotted interior edge of the of the window frame in a manner that allows the resident to slide the window screen to one side of the window frame and then pull the window screen out of the window. In order to prevent the window screen from falling out of the window, the screen frame is slightly larger than the opening of the window. Although this is beneficial with regard to the window screen not falling out of the window, it makes removal of the window screen from the window more difficult. In order to remove the window screen the resident or someone on his or her behalf must slightly bend or twist the window screen to dislodge it from the window. Generally, the flexible screen frame and mesh panel are configured to allow removal of the screen. Often, however, the resident pulls, bends and/or twists the window screen too aggressively, resulting in damage to the window screen, which damage can be exasperated by use of a screwdriver or other prying tool. In fact, it is common to replace window screens due to such damage. If it is not replaced, the bent or twisted window screen can allow insects, dust, debris and the like inside the home and provides a generally unsightly exterior appearance for the home.

What is needed, therefore, is an improved window screen that is configured to allow a resident or other person to easily, quickly and without damage to the window screen, window frame or window to remove the window screen from the window. The improved window screen should be configured to fit within and cooperate with standard window frames so the resident can utilize his or her existing windows. Preferably, an improved window screen should have few moving components to reduce the cost of manufacturing the window screen and the likelihood that such components will be stuck or otherwise unuseable due to exposure to the outside elements. The improved window screen of the present invention should be adaptable for having the screen frame and mesh panel being manufactured out of materials which are at least generally consistent with the materials utilized with presently available window screens.

### SUMMARY OF THE INVENTION

The improved window screen of the present invention solves the problems and provides the benefits identified above. That is to say, the present invention is a window screen which can be easily and quickly removed from a window frame without damaging the window screen, window frame or window. In a preferred embodiment, the window screen of the present invention is sized and configured to fit within standard sizes and configurations of window frames and is configured to cooperatively engage such window frames so the resident can use the improved window frame with existing windows. The improved window screen of the present invention comprises very few moving components, resulting in a relatively inexpensive window frame that is easy to use and less likely to become stuck or otherwise inoperable due to exposure to the elements, including dust, rain and the like. The screen frame and mesh panel of the improved window screen of the present invention can be manufactured out of materials which are utilized with existing window screens.

In a primary embodiment of the present invention, the improved window screen comprises a screen frame having a first C-shaped section and a second C-shaped section that are slidably engaged, a mesh panel and a securing mechanism. The first C-shaped section has an upper frame member, a lower frame member and a side member. The upper frame member has a first upper end and the lower frame member has a first lower end. The second C-shaped section has a tubular upper frame member, a tubular lower frame member and a side member. The tubular upper frame member has a first upper end and the tubular lower frame member has a first lower end. The tubular upper frame member of the second C-shaped member is sized and configured to slidably receive the upper frame member of the first C-shaped member. The tubular lower frame member of the second C-shaped member is sized and configured to slidably receive the lower frame member of the first C-shaped member. The mesh panel is attached to the screen frame and interconnects each of the frame members of the first C-shaped section and each of the frame members of the second C-shaped section. The improved window screen has an upper securing mechanism at the upper frame member of the first C-shaped section and the upper frame member of the second C-shaped section and a lower securing mechanism at the lower frame member of the first C-shaped section and the lower frame member of the second C-shaped section. The upper and lower securing mechanisms secure the screen frame in an extended position for use inside a window frame to screen the opening thereof. Both securing mechanisms are configured to be selectively disengaged to allow the second C-shaped section to be slid towards the first C-shaped section and place the screen frame in a retracted position to install or remove the window screen from the window frame. In a preferred embodiment, the securing mechanisms are ball detent devices having a button on each of the upper frame member and the lower frame member of the first C-shaped section and an aperture on each of the upper frame member and the lower frame member of the second C-shaped section. The buttons and the apertures are cooperatively configured for the button to be engagedly received in the aperture to secure the screen frame in its extended position and then disengaged to place the screen frame in its retracted position. If desired, the window screen can also comprise a stop mechanism at each of the upper frame members and each of the lower frame members that is configured to prevent full disengagement of the first C-shaped section from the second C-shaped section.

Accordingly, one of the primary aspects of the present invention is to provide an improved window screen that has the advantages discussed above and which overcomes the disadvantages and limitations associated with presently available window screens.

It is an important aspect of the present invention to provide an improved window screen that allows the resident to easily and quickly remove the window screen from a window frame without damage to the window screen, window frame or window.

It is also an important aspect of the present invention to provide an improved window screen that is configured to be received in and secured by an existing window frame so the resident does not have to replace the window in order to utilize the improved window screen.

Another important aspect of the present invention is to provide an improved window screen that can be manufactured with few moving components so as to reduce the manufacturing costs and the likelihood that the window screen will become stuck or otherwise inoperable over time.

Yet another important aspect of the present invention is to provide an improved window screen that has a screen frame and mesh panel which can be manufactured out of materials commonly utilized for such components.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a prior art window screen;

FIG. 2 is a front view of the prior art window screen of FIG. 1 shown installed in a prior art window frame;

FIG. 3 is a front view of an improved window screen that is configured according to a preferred embodiment of the present invention shown in its extended position;

FIG. 4 is a front view of the improved window screen of FIG. 3 shown in its retracted position for removal from a window frame;

FIG. 5 is an exploded front view of the screen frame utilized with the improved window screen of FIGS. 3 and 4; and

FIG. 6 is an isolated end view of the lower corner of the improved window screen of FIG. 3 showing the detent device extending above the frame member.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the improved window screen, those skilled in the art will readily understand that this is merely for purposes of simplifying the present disclosure and that the present invention is not so limited. In addition, although the description herein is primarily directed to use of the improved window screen in a home, those skilled in the art will readily understand that the present window screen can be utilized in offices, factories, schools and other buildings where it is desirable to have a window screen removably disposed in a window.

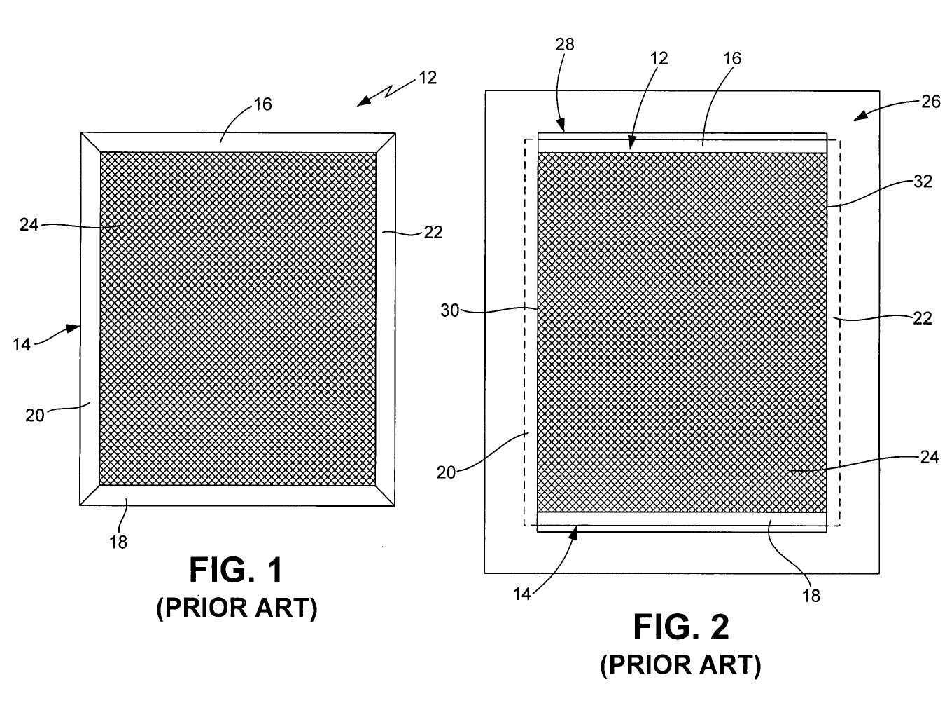

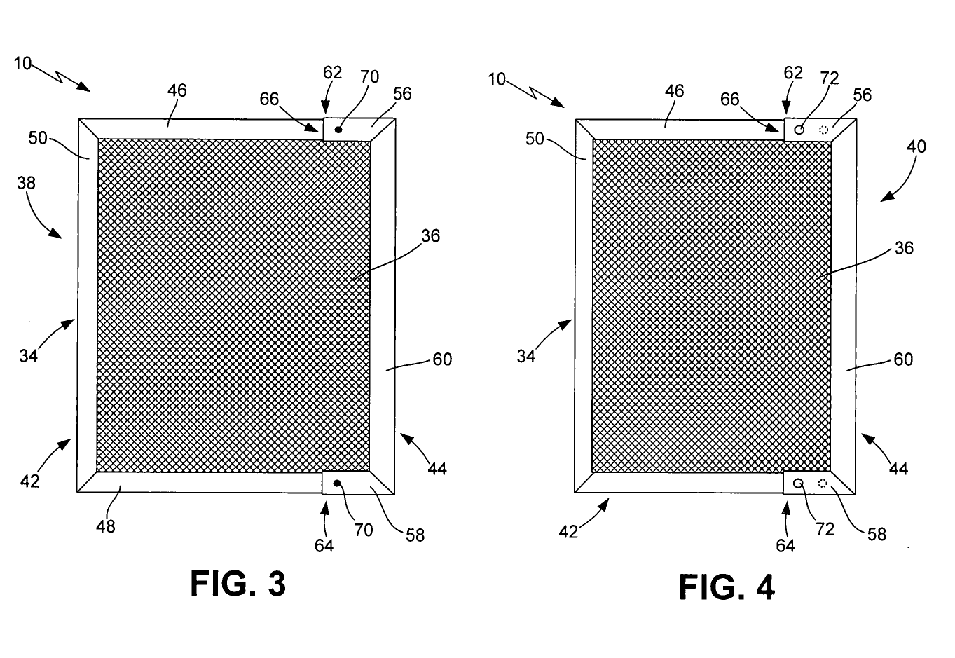

An improved window screen that is configured pursuant to a preferred embodiment of the present invention is identified generally as 10 in FIGS. 3 and 4. As shown in FIGS. 1 and 2, prior art window screens 12 comprise a screen frame 14 having a plurality of frame members, namely an upper frame member 16, a lower frame member 18, a first side frame member 20 and a second side frame member 22, and a mesh panel 24 stretched between and attached to the frame members 16-22. The frame members 16-22 are fixedly joined together at the corners of the screen frame 14. As stated above, frame members 16-22 are typically manufactured out of aluminum, fiberglass, plastic or other lightweight weather resistant materials or made out of wood. The mesh panel 24 is most commonly manufactured out of aluminum, fiberglass or synthetic fiber mesh.

The prior art window screen is sized and configured to be removably supported in and by the window frame 26, an example of which is shown in FIG. 2. The screen frame 14 and the mesh panel 24 of the prior art window screen 12 are made to be flexible enough to allow the resident to slightly bend or twist the prior art window screen 12 to remove it from the standard window frame 26. In one configuration, window frame 26 has an opening 28 that is defined by a plurality of interior edges, including first side edge 30 and second side edge 32, that each have a slot-like section which receives the first side frame member 20 and second side frame member 22, respectively, of the prior art window screen 12, as shown in FIG. 2. In the embodiment shown, the window screen 12 is made to be slightly larger (wider) than the opening 28 so the side members of the window frame 26 retain the window screen 12 across the opening 28. Some combination window screens 12 and window frames 26 are configured for the window screen 12 to be slightly taller than the opening 28 such that the window screen 12 is vertically retained in the window frame 26 by the top and bottom window frame members instead of the side members.

As set forth above, it is common for the resident to excessively bend or twist the prior art window screen 12 in an effort to remove it from window frame 26, which often results in damage to the window screen 12 and/or the window frame 26. The likelihood of damage is increased if the resident uses of a screwdriver or other prying device to assist him or her in removing the window screen 12 from the window frame 26. Typically, damage to the window screen 12 consists of one or more of the frame members 16-22 being bent or broken. This damage is usually very difficult to repair due to the materials used for the window screen 12 and the manner in which the mesh panel 24 is joined to the screen frame 14. Besides being unsightly on the exterior of the home, a window screen 12 which is damaged in this manner is not able to prevent insects, dust, debris or the like from entering into the home through the open window past the damaged component or components of the window screen 12. To be able to leave the window open and eliminate the unsightly damage, the resident usually must replace the window screen 12.

The improved window screen 10 of the present invention solves the problems associated with the prior art window screen. More specifically, the window screen 10 allows the resident to easily and quickly remove the window screen 10 from the window frame 26. The screen frame 34 and mesh panel 36 of window screen 10 are manufactured out of the same materials and in the same sizes and configurations as the prior art window screen 12. As set forth in more detail below, the improved window screen 10 is configured such that the resident can move window screen 10 between its normal use extended position 38, shown in FIG. 3, and its retracted position 40, shown in FIG. 4. The window screen 10 will be in its extended position 38 during use in window frame 26 and be moved to its retracted position 40 when the resident desires to remove window screen 10 from window frame 26 or place window screen 10 inside window frame 26. In the retracted position 40, the width of the window screen 10 is less than the width of the opening 28 of window frame 26, thereby eliminating the need for the resident to bend or twist the window screen 10 in order to remove or install window screen 10 in the window frame 26.

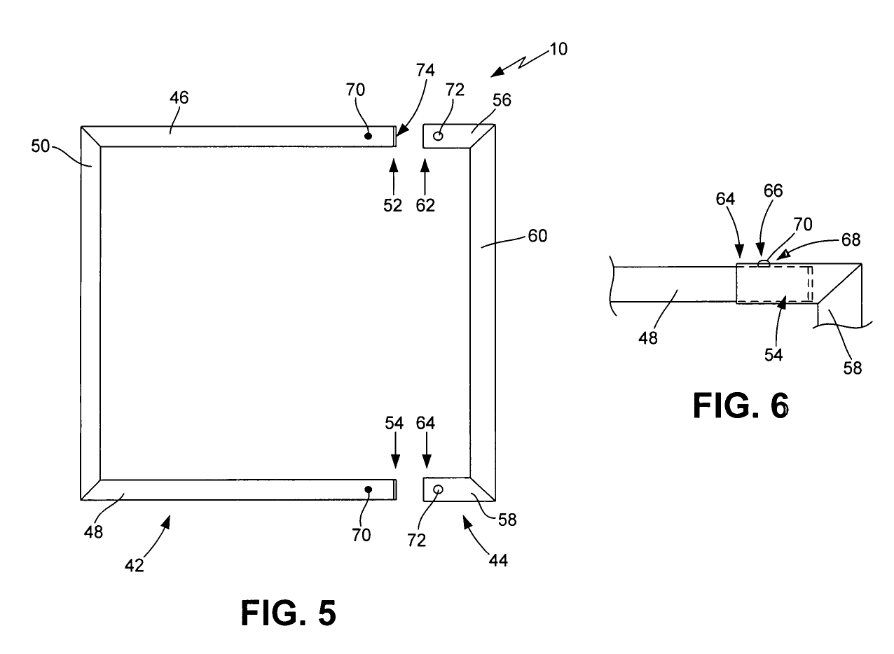

As best shown in FIG. 5, the screen frame 34 of the window screen 10, shown without mesh panel 36, comprises a first C-shaped section 42 and a cooperatively configured, backward facing second C-shaped section 44. The first C-shaped section 42, shown on the left side of FIG. 5, has an upper member 46, a lower member 48 and a side member 50, with a first upper end 52 at the end of upper member 46 and a first lower end 54 at the end of lower member 48. The second C-shaped section 44, shown on the right side of FIG. 5, has an upper member 56, a lower member 58 and a side member 60, with a second upper end 62 at the end of upper member 56 and a second lower end 64 at the end of lower member 58. In the embodiment shown in FIGS. 3 through 6, the upper 62 and lower 64 ends of the second C-shaped section 44 are tubular and the upper 52 and lower 54 ends of the first C-shaped section 42 are sized and configured to be slidably received inside the upper 62 and lower 64 ends, respectively, of second C-shaped section 44, as shown in FIGS. 3, 4 and 6. As will be readily apparent to those skilled in the art, the relative positioning of the tubular ends 62/64 and the ends 52/54 which are received therein can be reversed.

To function as a screen for use with standard window frames 26, the first C-shaped section 42 must be fixedly yet slidably joined to second C-shaped section 44 with a securing mechanism, which is shown generally as 66 in FIGS. 3, 4 and 6. A variety of securing mechanisms 66 can be utilized with the window screen 10 of the present invention. In the embodiment shown in the figures, the securing mechanism 66 comprises a spring-loaded ball detent device 68 having an upwardly disposed projection, typically in the form of a ball or button 70, which is best shown in FIG. 6. As shown in FIG. 5, the button 70 projects upwardly from the surface of upper member 46 and lower member 48 of the first C-shaped section 42 towards the respective ends 52/54 of members 46/48. The button 70 of each detent device 68 is sized and configured to be engagedly received by a cooperatively configured aperture 72 in the corresponding upper member 56 and lower member 58 of the second C-shaped section 44, as best shown in FIGS. 3 and 6, to substantially block the relative sliding movement of first 42 and second 44 C-shaped sections. As well known in the art of such securing mechanisms 66, button 70 is pushed downward to allow the upper 46 and lower 48 members of first C-shaped section 42 to slide relative to the upper 56 and lower 58 members of the second C-shaped section 44. When the button 70 is in position in aperture 72 the button 70 will project upward to engage the aperture 72, as best shown in FIG. 6. The two C-shaped sections 42/44 are joined by inserting the upper 52 and lower 54 ends of first C-shaped section 42 into the tubular upper 62 and lower 64 ends of the second C-shaped section 44 and then sliding the members 46/56 and 48/58 relative to each other until the button 70 engages the aperture 72. Once the button 70 is received inside the aperture 72, the two C-shaped sections 42/44 will be fixedly joined together in the extended position 38, as shown in FIG. 3, to provide a screened closure for the opening 28 of window frame 26. To remove window screen 10 from window frame 26, the user pushes buttons 70 down and slides the second C-shaped section 44 towards the first C-shaped section 42 until the window screen 10 is in its retracted position 40 and window screen 10 can be easily and quickly removed from window frame 26 due to its being smaller (narrower) than opening 28.

The mesh panel 36 of window screen 10 is sufficiently flexible to allow the sliding movement of the frame members 46/56 and 48/58 discussed above, which only requires a sliding distance that reduces the width of window screen 10 to less than that of opening 28. Because the frame members of the two C-shaped sections 42/44 do not have to bend or twist to remove it from the window frame 26, they can be manufactured, if desired, to be rigid instead of flexible. If desired, the window screen 10 can be provided with a stop mechanism 74 that prevents complete removal of first C-shaped section 42 from the second C-shaped section 44. On such stop mechanism 74 is to provide the upper 52 and lower 54 ends of the first C-shaped section 42 with a stop member that abuts an inside edge of the upper 62 and lower 64 ends of second C-shaped section 44 such that the ends 52/54 cannot be moved past the ends 62/64. Normally, stop mechanism 74 will not be necessary for use with window screen 10 because the mesh panel 36 will generally have sufficient tensile strength to prevent the full disengagement of the second C-shaped section 44 from the first C-shaped section 42.

In use, the resident will typically purchase a window that has the window screen 10 or purchase window screen 10 for use with an existing window. The window screen 10 will be sized and configured for the size and configuration of window frame 26. To remove the window screen 10 from the window frame 26, the resident will push in the buttons 70 until they are below the apertures 72 and then slide second C-shaped section 44 towards the first C-shaped section 42, causing the buttons 70 to move under the top surface of the upper 56 and lower 58 members of the second C-shaped section, as shown in FIG. 4, to place the window frame 10 in its retracted position 40. In this position, window screen 10 can be easily and quickly removed from window frame 26 through opening 28. To reinstall the window screen 10 in window frame 26, the resident places the window screen 10, while in its retracted position 40, inside opening 28 of window frame 26. Once in position in window frame 26, the user moves the second C-shaped section 44 away from the first C-shaped section 42 until each of the buttons 70 engages their respective apertures 72 to secure the two C-shaped sections 42/44 together, as shown in FIG. 3. The window screen 10 of the present invention does not require any bending or twisting of window screen 10 and, as such, will reduce the likelihood of damage to the window screen 10 or window frame 26 from prying or other removal efforts.

As will be readily apparent to those skilled in the art, the window screen 10 of the present invention can be adapted for use with a window screen and window system that utilizes a window screen which is vertically disposed in the window frame 26 instead of being horizontally disposed as described above. As such, the terms “upper” and “lower” are not intended to limit the window screen 10 of the present invention in any manner are merely utilized to for purposes of clarity and brevity to describe the present invention.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A window screen, comprising:
a screen frame having a first C-shaped section and a second C-shaped section, each of said first C-shaped section and said second C-shaped section comprising at least an upper frame member and a lower frame member, said upper frame member of said first C-shaped section slidably received inside said upper frame member of said second C-shaped section and said lower frame member of said first C-shaped section slidably received inside said lower frame member of said second C-shaped section to allow said screen frame to move between an extended position and a retracted position;
a mesh panel attached to said screen frame and interconnecting each of said frame members of said first C-shaped section and each of said frame members of said second C-shaped section; and
securing means interconnecting said upper frame member of said first C-shaped section and said upper frame member of said second C-shaped section and interconnecting said lower frame member of said first C-shaped section and said lower frame member of said second C-shaped section for securing said screen frame in said extended position, said securing means configured to be selectively disengaged to place said screen in said retracted position by sliding said second C-shaped section towards said first C-shaped section.

2. The window screen of claim 1, wherein said securing means comprises a ball detent device.

3. The window screen of claim 2, wherein said ball detent device comprises a button on each of said upper frame member and said lower frame member of said first C-shaped section and an aperture on each of said upper frame member and said lower frame member of said second C-shaped section, said buttons and said apertures cooperatively configured for said button to be engagedly received in said aperture.

4. The window screen of claim 1 further comprising a stop mechanism at each of said upper frame members and each of said lower frame members, said stop mechanism configured to prevent full disengagement of said first C-shaped section from said second C-shaped section.

5. A window screen, comprising:
a screen frame having a first C-shaped section and a second C-shaped section, said first C-shaped section having an upper frame member, a lower frame member and a side member, said upper frame member having a first upper end and said lower frame member having a first lower end, said second C-shaped section having a tubular upper frame member, a tubular lower frame member and a side member, said tubular upper frame member having a first upper end and said tubular lower frame member having a first lower end, said tubular upper frame member of said second C-shaped member sized and configured to slidably receive said upper frame member of said first C-shaped member and said tubular lower frame member of said second C-shaped member sized and configured to slidably receive said lower frame member of said first C-shaped member;
a mesh panel attached to said screen frame and interconnecting each of said frame members of said first C-shaped section and each of said frame members of said second C-shaped section; and
securing means at said upper frame member of said first C-shaped section and said upper frame member of said second C-shaped section and at said lower frame member of said first C-shaped section and said lower frame member of said second C-shaped section for securing said screen frame in an extended position, said securing means configured to be selectively disengaged to place said screen frame in a retracted position by sliding said second C-shaped section towards said first C-shaped section.

6. The window screen of claim 5, wherein said securing means comprises a ball detent device.

7. The window screen of claim 6, wherein said ball detent device comprises a button on each of said upper frame member and said lower frame member of said first C-shaped section and an aperture on each of said upper frame member and said lower frame member of said second C-shaped section, said buttons and said apertures cooperatively configured for said button to be engagedly received in said aperture.

8. The window screen of claim 5 further comprising a stop mechanism at each of said upper frame members and each of said lower frame members, said stop mechanism configured to prevent full disengagement of said first C-shaped section from said second C-shaped section.
